(19) United States
(12) Patent Application Publication
(10) Pub. No.: US 2005/0161898 A1
(43) Pub. Date: Jul. 28, 2005

(54) Connective components of aluminum parallel telescopic crossbars of stretchable bicycle

(76) Inventor: Hung-Chang Chao, Taipei (TW)

Correspondence Address: BACON & THOMAS, PLLC, 625 SLATERS LANE, FOURTH FLOOR, ALEXANDRIA, VA, 22314, US

(21) Appl. No.: 11/014,872

(22) Filed: Dec. 20, 2004

(30) Foreign Application Priority Data
Dec. 22, 2003 (TW) 092222417

(51) Int. Cl. B62K 1/00

(52) U.S. Cl. 280/278

(57) ABSTRACT

Provided are parallel crossbars mounted in a stretchable bicycle comprising unitary front and rear connecting devices made of aluminum formed by extrusion, either connecting device comprising two parallel channels each having an open inner side being in communication with the open inner side of the other channel, upper and lower plates formed between the channels, and two openings formed on the upper and lower plates respectively wherein a head tube or seat tube has its upper end fixedly connected to the openings; two sliding tubes adapted to slide through the channels respectively; and a plurality of quick releases each comprising a bolt having a threaded end inserted through the plates, a nut threadedly secured to the bolt, a lever, and a cam shaped pivot. Pivoting the lever downward about the pivot will flexibly compress the plates toward each other for fastening the sliding tubes.

### FIELD OF THE INVENTION

The present invention relates to frame of stretchable bicycle and more particularly to such a stretchable bicycle having a pair of telescopic parallel crossbars made of aluminum formed by extrusion in which the parallel crossbars have a plurality of (e.g., preferably two) improved connective components.

### BACKGROUND OF THE INVENTION

Stretchable bicycles are advantageous for enabling a rider to adjust its length for facilitating storage or shipping. As such, stretchable bicycles are gaining popularity recently. A prior stretchable bicycle is shown in FIG. 9. The crossbar is divided into a front section 90 and a rear section 91 in which the front section 90 is adapted to slide inside the rear section 91 for length adjustment purpose, and a fastener (e.g., bolt and nut combination) is then driven home to fasten them together. The bicycle further comprises a front tube 93 fixedly connected to the front section 90, a seat tube 92 fixedly connected to the rear section 91, and sprocket wheels 96. In driving, a driver may rotate foot pedals 95 to move the bicycle forward by rotating the sprocket wheels 96 as known in the art. A forward component force for moving the bicycle forward and a lateral component force for tilting the bicycle are created when the bicycle is moving forward. Further, torsion is produced in the joining portion (i.e., at the fastener 94) of the front and rear sections 90 and 91. The torsion may adversely affect the dynamic balance of the bicycle. As such, the maneuverability of the bicycle decreases and even the driver may fall.

There have been some suggestions in prior art for solving the torsion problem. However, so far as the present inventor is aware, such prior mechanisms are typically relatively complex in constructions, costly to manufacture due to high precision requirements, trouble-prone, and unreliable in use. Thus, the need for improvement still exists.

### SUMMARY OF THE INVENTION

It is an object of the present invention to provide connective components of aluminum parallel crossbars of stretchable bicycle such that the parallelism of the parallel crossbars can be well maintained. Also, the sliding tubes are adapted to smoothly slide in the crossbars.

It is another object of the present invention to provide connective components of aluminum parallel crossbars of stretchable bicycle such that high manufacturing precision is not required, resulting in a reduction of the manufacturing cost.

It is yet another object of the present invention to provide connective components of aluminum parallel crossbars of stretchable bicycle as such the telescopic parallel crossbars made of aluminum formed by extrusion are light weight for significantly reducing the weight of the bicycle.

It is a further object of the present invention to provide connective components of aluminum parallel crossbars of stretchable bicycle such that the assembly or disassembly is made easy by providing the quick releases.

The above and other objects of the present invention are realized by providing a pair of parallel crossbars mountable in a stretchable bicycle comprising a unitary front connecting device made of aluminum formed by extrusion, the front connecting device comprising two parallel channels each having an open inner side being in communication with the open inner side of the other channel, upper and lower plates formed between the channels, and upper and lower first openings formed on the upper and lower plates respectively wherein a head tube has its upper end fixedly connected to the first openings; a unitary rear connecting device made of aluminum formed by extrusion, the rear connecting device comprising two parallel channels each having an open inner side being in communication with the open inner side of the other channel, upper and lower plates formed between the channels, and upper and lower second openings formed on the upper and lower plates respectively wherein a seat tube has its upper end fixedly connected to the second openings; two sliding tubes adapted to slide through the channels respectively; and a plurality of quick releases each comprising a bolt having a threaded end inserted through the plates, a nut threadedly secured to the bolt, a lever, and a pivot interconnected one end of the lever and an upper end of the bolt wherein the pivot has a cam portion such that pivoting the lever downward about the pivot will turn the cam portion to flexibly compress the plates toward each other for fastening the sliding tubes.

The above and other objects, features and advantages of the present invention will become apparent from the following detailed description taken with the accompanying drawings.

### BRIEF DESCRIPTION OF THE DRAWINGS

FIG. 1 is a perspective view of a pair of telescopic parallel crossbars according to a first preferred embodiment of the invention to be mounted in a stretchable bicycle;

FIG. 2 is an exploded view of a rear one of the connecting devices of FIG. 1;

FIGS. 3 and 4 are sectional views taken along lines 3-3 and 4-4 of FIG. 1 respectively;

FIG. 5 is a perspective view of a stretchable bicycle incorporating the parallel crossbars of the invention of FIG. 1, where the parallel crossbars are fully extended;

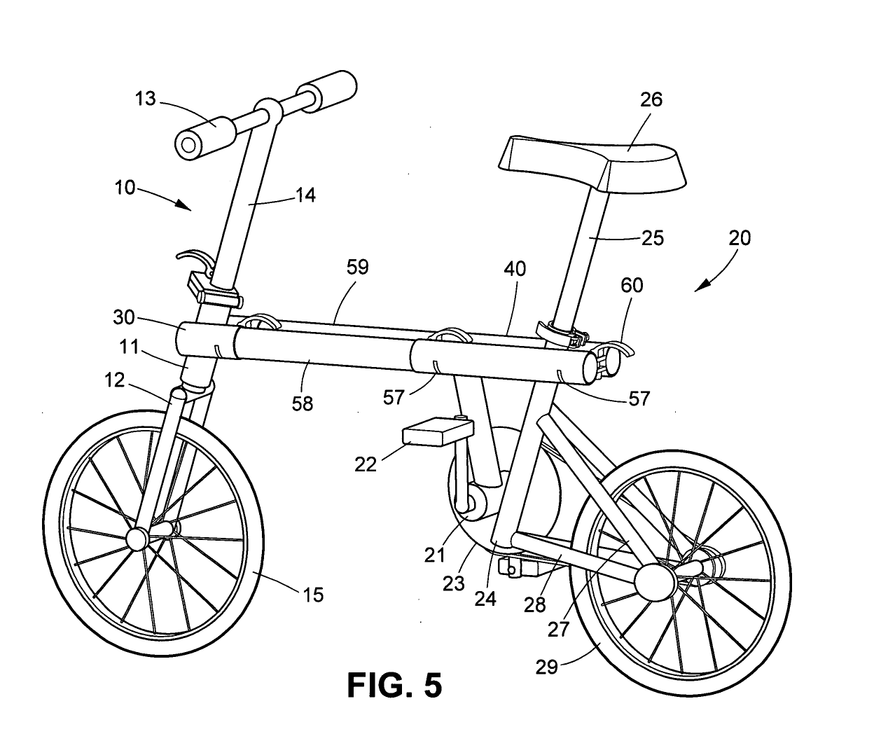

FIG. 6 is a view similar to FIG. 5, where the parallel crossbars are fully retracted;

FIG. 7 is an exploded view of a rear one of connecting devices to be connected to a pair of sliding tubes according to a second preferred embodiment of the invention; and

FIG. 8 is a sectional view of the assembled connecting devices and the sliding tubes of FIG. 7; and

FIG. 9 is a side view of a prior stretchable bicycle.

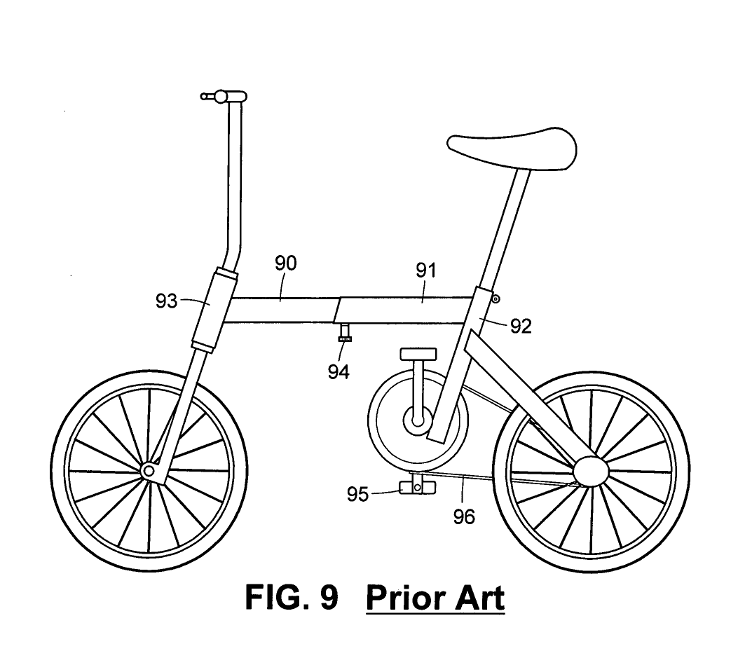

### DETAILED DESCRIPTION OF THE PREFERRED EMBODIMENTS

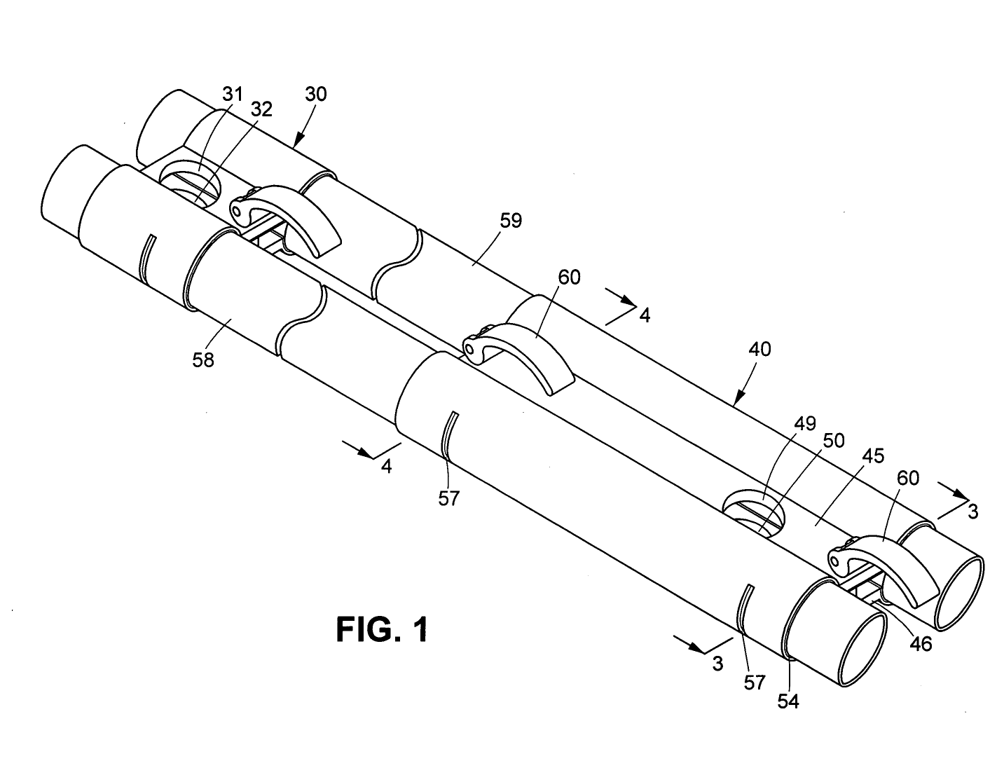

Referring to FIG. 1, a stretchable bicycle incorporating a pair of telescopic parallel crossbars made of aluminum formed by extrusion according to a first preferred embodiment of the invention is shown. The frame of the bicycle comprises a front frame section 10 and a rear frame section 20. The front frame section 10 comprises a head tube 11, a fork 12, two handlebars 13, a stem 14 interconnected the handlebars 13 and the head tube 11, and a front wheel 15. The rear frame section 20 comprises a bottom bracket 21, a pair of pedals 22 connected to the bottom bracket 21, sprocket wheels 23 connected to the bottom bracket 21, a rear wheel 29, a chain stay 28 extended rearward from the bottom bracket 21 to an axle of the rear wheel 29, a seat tube 24 extended upwardly from the bottom bracket 21, a seat stay 27 having a rear end connected to the axle of the rear wheel 29, and a seat post 25 slidably inserted into the seat tube 24. The above components are well known devices. Therefore, further description thereof is omitted for purposes of brevity and convenience only, and is not limiting. The characteristic of the invention is the provision of the parallel crossbars as detailed below. The parallel crossbars comprise a front connecting device 30, a rear connecting device 40, two sliding tubes 58, 59, and a plurality of fasteners (e.g., quick releases) 60. Each component is discussed in detailed below. Note that only the rear connecting device 40 will be described since the front connecting device 30 is generally identical thereto except its length.

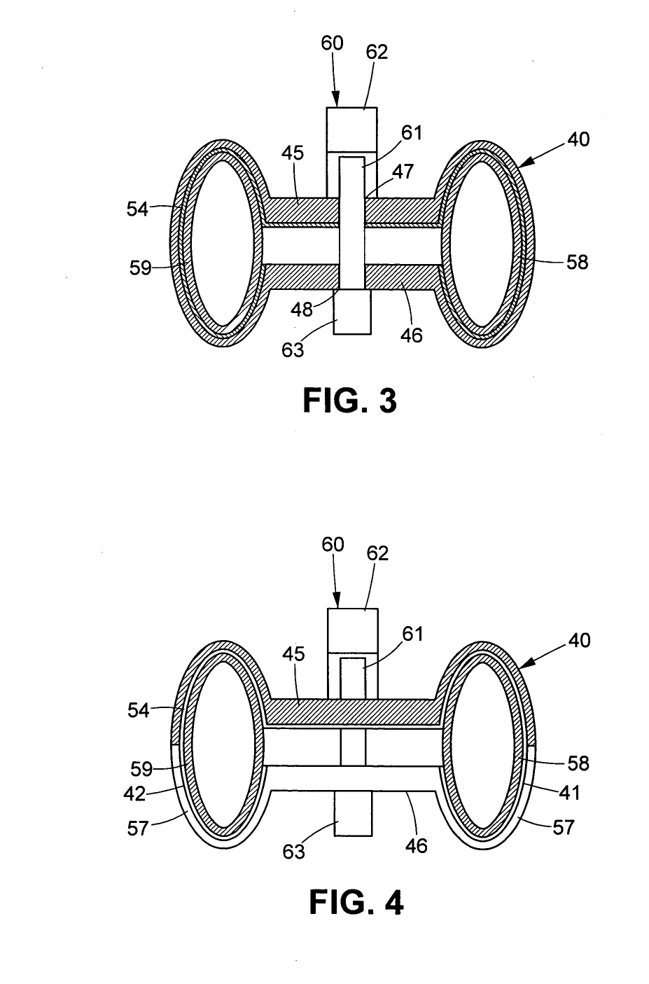

Referring to FIGS. 1 to 4, the unitary rear connecting device 40 is made of aluminum formed by extrusion. The connecting device 40 comprises two parallel channels 41, 42 each open to both ends. Each of the connecting device 40 and the cooperating sliding tubes 58, 59 has a section of circle in this embodiment. Alternatively, other sections (e.g., triangle, rectangle, etc.) are possible in certain embodiments. The adjacent portions of the connecting devices 41, 42 are open (i.e., openings 43, 44) with an upper plate 45 and a lower plate 46 formed therebetween to define a passage having a section of rectangle. The sliding tubes 58, 59 are adapted to slide through the channels 41, 42 respectively. A pair of upper and lower holes 47, 48 are formed at either end of the upper and lower plates 45, 46 respectively. Also, a pair of upper and lower openings 49, 50 are formed on the upper and lower plates 45, 46 respectively. The seat tube 24 has its upper end fixedly connected to the openings 49, 50 (i.e., the connecting device 40) by welding or soldering known in the art. The parallelism of the channels 41, 42 is not adversely affected by the welded or soldered portion.

The quick release 60 is a well known device and comprises a bolt 61 having a threaded end inserted through the holes 47, 48, a nut 63 threadedly secured to the bolt 61, a curved lever 62, and a pivot 64 pivotably interconnected one end of the lever 62 and an upper end of the bolt 61, the pivot 64 having a cam portion such that pivoting the lever 62 downward about the pivot 64 will turn the cam portion of the pivot 64 to flexibly compress the plates 45, 46 toward each other. As a result, the sliding tubes 58, 59 are fastened. For unfastening the sliding tubes 58, 59, the steps discussed in this paragraph are traversed in the opposite direction.

For enhancing the flexibility of the connecting device 40 when the sliding tubes 58, 59 are fastened by the quick releases 60, a curved peripheral (i.e., substantially half-circular) groove 57 is formed on either channel 41 or 42 proximate its either end (see FIG. 4). As shown, two grooves 57 at the same end of the connecting device 40 are aligned with the holes 47, 48. In one example, substantially one end of the groove 57 is terminated at an outermost point of the channel 41 and the other end is terminated at the opening 43 of the channel 41. The grooves 57 are adapted to flexibly decrease its width when the connecting device 40 and the sliding tubes 58, 59 are fastened by the quick releases 60.

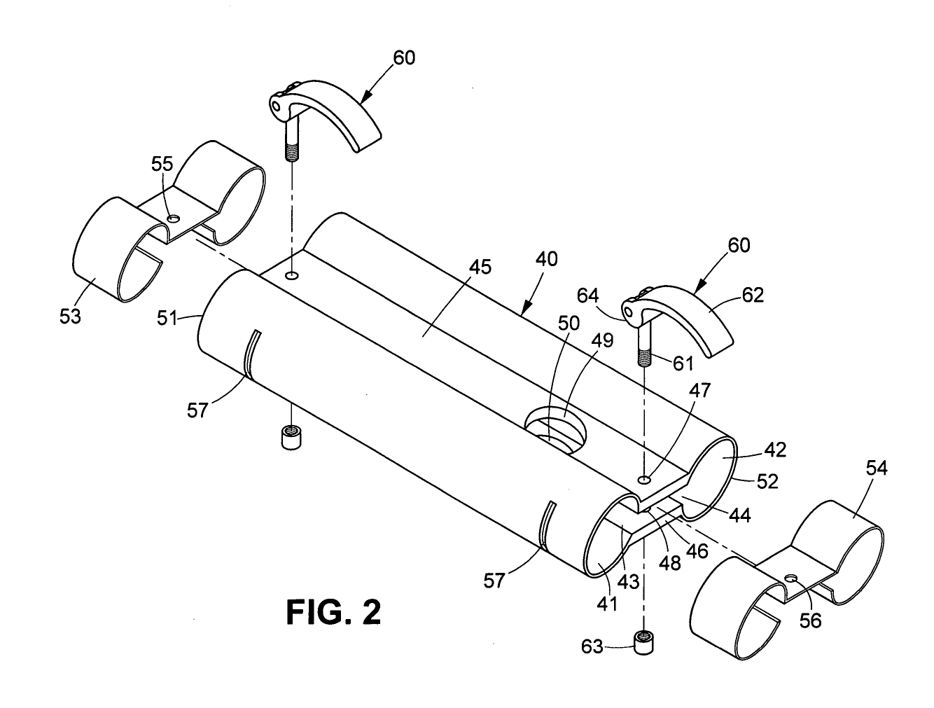

Referring to FIG. 2 specifically, two friction reduction members 53, 54 with smooth surfaces formed by molded plastic are provided at both ends of the connecting device 40. For example, the friction reduction member 54 comprises two side bushings shaped to neatly insert into the channels 41, 42, and an interconnected bridge having an aperture 56 with the bolt 61 passed for positioning. The sliding tubes 58, 59 pass the bushings of the friction reduction members 53, 54 when they are inserted into the channels 41, 42 respectively. As such, sliding the sliding tubes 58, 59 in the channels 41, 42 is facilitated. The bushing is of C-shaped for increasing its flexibility when it is fastened by the quick release 60.

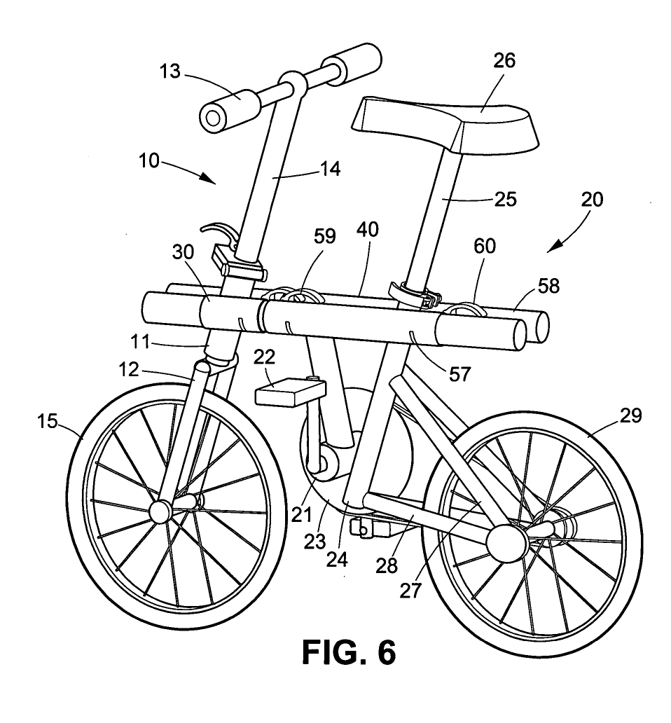

Referring to FIG. 6, each of the sliding tubes 58, 59 has its front end passed a front end of the front connecting device 30 and its rear end passed a rear end of the rear connecting device 40 respectively. In this state, length of the bicycle is reduced to a minimum. The bicycle is implemented as a stretchable bicycle having 10-inch or 12-inch wheels (i.e., small bicycle) or a stretchable bicycle having a prolonged crossbar. Alternatively, a driver may remove one of the sliding tubes 58, 59 (i.e., one having battery mounted therein) for charging when the stretchable bicycle is propelled by electricity. That is, there is no need to exert a great force to move the bicycle to a charging station for charging.

For a stretchable bicycle having two at least 14-inch wheels (i.e., large bicycle), no length adjustment mechanism is necessary. As such, the above quick releases are replaced with a number of typical bolt and nut combinations. Thus, once the sliding tubes 58, 59 are fastened across the connecting devices 30, 40 by the bolt and nut combinations, a driver will not do the unfastening and fastening again in most cases.

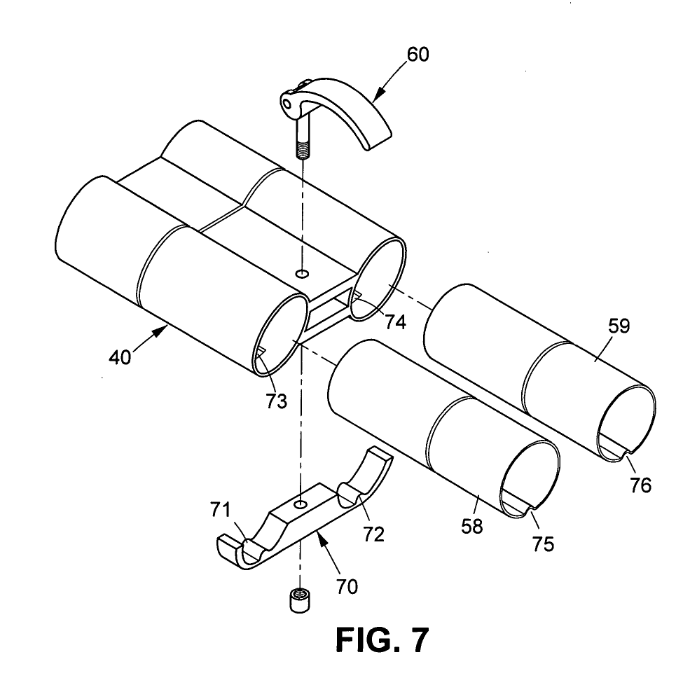

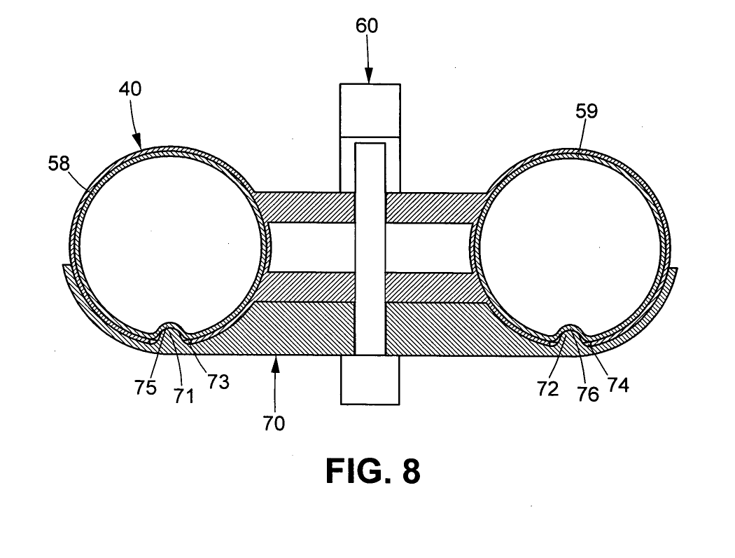

Referring to FIGS. 7 and 8, a second preferred embodiment of the invention is shown. The second preferred embodiment substantially has same structure as the first preferred embodiment. The differences between the first and the second preferred embodiments, i.e., the characteristics of the second preferred embodiment are detailed below. An elongated abutment member 70 has two upwardly curved ends, a central hole, and two upper ridges 71, 72 each formed between the hole and the curved end. Two openings 73, 74 are formed on bottoms of the connecting device 40 proximate its one end. Two short inwardly recessed troughs 75 and 76 are formed on bottoms of the sliding tubes 58, 59 respectively. In assembly, the sliding tubes 58, 59 are inserted into the connecting device 40 with the troughs 75, 76 above the openings 73, 74 respectively. Next, put the abutment member 70 onto the bottom of the connecting device 40 with its ridges 71, 72 passed the openings 73, 74 respectively. Next, insert the bolt of the quick release 60 through the holes 47, 48 and the hole of the abutment member 70 prior to threadedly securing to the nut 63 (see FIGS. 2, 3, and 4). Finally, pivot the lever 62 downward about the pivot 64 to fasten the sliding tubes 58, 59. In this state, the ridges 71, 72 are lockingly engaged with the troughs 75, 76 respectively. Also, the openings 43, 44 are eliminated. That is, the channel has a section of circle. Such arrangement aims at enhancing the rigidity of the connecting device 40.

The invention has the following advantages. i) The parallelism of the parallel crossbars can be well maintained. Also, the sliding tubes are adapted to smoothly slide in the crossbars. ii) High precision is not required, resulting in a reduction of the manufacturing cost. iii) The pairs of telescopic parallel crossbars made of aluminum formed by extrusion are light weight such that the weight of the bicycle can be reduced significantly. iv) The assembly or disassembly is made easy by providing the quick releases.

While the invention herein disclosed has been described by means of specific embodiments, numerous modifications and variations could be made thereto by those skilled in the art without departing from the scope of the invention set forth in the claims.

1. A pair of parallel crossbars mountable in a stretchable bicycle comprising:
a unitary front connecting device made of aluminum formed by extrusion, the front connecting device comprising two parallel channels each having an open inner side being in communication with the open inner side of the other channel, upper and lower plates formed between the channels, and upper and lower first openings formed on the upper and lower plates respectively wherein
a head tube has its upper end fixedly connected to the first openings;
a unitary rear connecting device made of aluminum formed by extrusion, the rear connecting device comprising two parallel channels each having an open inner side being in communication with the open inner side of the other channel, upper and lower plates formed between the channels, and upper and lower second openings formed on the upper and lower plates respectively wherein a seat tube has its upper end fixedly connected to the second openings;
two sliding tubes adapted to slide through the channels respectively; and
a plurality of quick releases each comprising a bolt having a threaded end inserted through the plates, a nut threadedly secured to the bolt, a lever, and a pivot interconnected one end of the lever and an upper end of the bolt wherein the pivot has a cam portion such that pivoting the lever downward about the pivot will turn the cam portion to flexibly compress the plates toward each other for fastening the sliding tubes.

2. The parallel crossbars of claim 1, further comprising a curved peripheral groove formed on either channel proximate its either end.

3. The parallel crossbars of claim 2, wherein two grooves at the same end of either connecting device, and wherein one end of the groove is substantially terminated at an outermost point of the channel and the other end is terminated at the open inner side of the channel.

4. The parallel crossbars of claim 1, further comprising two friction reduction members each including two side bushings shaped to neatly insert into both ends of either channel of either connecting device, and a bridge having an aperture with the bolt passed.

5. The parallel crossbars of claim 1, wherein the number of the quick releases is three, and wherein the first quick release is disposed in a rear end of the front connecting device at the plates, the second quick release is disposed in a front end of the rear connecting device at the plates, and the third quick release is disposed in a rear end of the rear connecting device at the plates.

6. The parallel crossbars of claim 1, further comprising an elongated abutment member including two upwardly curved ends, a central hole, and two upper ridges each formed between the hole and the curved end, two slots formed on a bottom of either connecting device proximate its one end, and an inwardly recessed trough formed on a bottom of each sliding tube, and wherein the inserted sliding tubes have the troughs being urged by the ridges projected through the slots, insert the bolt through the hole, and threadedly secure the nut to the bolt in response to putting the abutment member onto the bottom of either connecting device.
